(19) United States
(12) Patent Application Publication
(10) Pub. No.: US 2008/0165300 A1
(43) Pub. Date: Jul. 10, 2008

(54) ACTIVE DEVICE ARRAY SUBSTRATE

(75) Inventors: Hui-Ming Sung, Taoyuan County (TW); Meng-Feng Hung, Taipei County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, omitted

(73) Assignee: CHUNGHWA PICTURE TUBES, LTD., Taipei (TW)

(21) Appl. No.: 11/945,236

(22) Filed: Nov. 26, 2007

(30) Foreign Application Priority Data
Jan. 9, 2007 (TW) 96100796

(51) Int. Cl. G02F 1/136

(52) U.S. Cl. 349/40

(57) ABSTRACT

An active device array substrate including a substrate, an active device array, pad sets, connecting lines, and switch devices is provided. The substrate has a display region and a peripheral circuit region, and the active device array is disposed on the display region. The pad sets are disposed on the peripheral circuit region and electrically connected to one other. Each pad set has a plurality of pads, and a portion of the pads is electrically connected to the active device array. The connecting lines are disposed on the peripheral circuit region, and the pad sets are electrically connected to each other by the connecting lines. The switch devices are disposed on the peripheral circuit region, and at least one of the switch devices is disposed between adjacent pads in each pad sets. Further, each switch device is electrically connected to the adjacent pads.

### CROSS-REFERENCE TO RELATED APPLICATION

This application claims the priority benefit of Taiwan application serial no. 96100796, filed on Jan. 9, 2007. The entirety of the above-mentioned patent application is hereby incorporated by reference herein and made a part of this specification.

### BACKGROUND OF THE INVENTION

1. Field of the Invention

The present invention relates to an active device array substrate, and more particularly, to an active device array substrate providing electrostatic discharge (ESD) protection.

2. Description of Related Art

With the recent advancement in electro-optical technology and semiconductor fabrication technology, flat display panels are being actively developed. Among all the existing flat display panels, a thin film transistor liquid crystal display (TFT-LCD) panel is currently the overwhelming choice of display panels due to its advantages such as low-voltage operation, fast response time, light weight and compactness.

A TFT-LCD mainly includes an LCD panel and a backlight module, wherein the LCD panel is formed by a color filter (CF) substrate, a thin film transistor (TFT) array substrate and a liquid crystal layer disposed between the color filter substrate and the TFT array substrate. The backlight module provides a plane light source required by the LCD panel to display images.

FIG. 1 schematically illustrates a conventional TFT array substrate. In FIG. 1, a TFT array substrate 100 includes a substrate 110, a plurality of scan lines 120, a plurality of data lines 130, a plurality of pixel units 150, a plurality of scan pads 160, a plurality of data pads 170, an inner guard ring 192, and an outer guard ring 194.

The substrate 110 has a display region 112 and a peripheral circuit region 114. Additionally, the scan lines 120 and the data lines 130 are disposed on the substrate 110, wherein the scan lines 120 and the data lines 130 divide the display region 112 into a plurality of pixel areas 140. The pixel units 150 are respectively disposed on one of the pixel areas 140 and are driven by the scan lines 120 and the data lines 130. Further, each pixel unit 150 is formed by a thin film transistor (TFT) 152 and a pixel electrode 154.

In FIG. 1, the scan pads 160 are disposed on the peripheral circuit region 114 and electrically connected to the scan lines 120. Moreover, the data pads 170 are disposed on the peripheral circuit region 114 and electrically connected to the data lines 130. The inner guard ring 192 is disposed on the peripheral circuit region 114, and is located between the scan pads 160 and the display region 112, and between the data pads 170 and the display region 112. In addition, the inner guard ring 192 is electrically connected to the scan lines 120 and the data lines 130 respectively. The inner guard ring 192 is formed by electrostatic discharge (ESD) protection devices 192a, such as thin film transistors or diodes. Furthermore, the outer guard ring 194 is disposed on the peripheral circuit region 114, and is located between the scan pads 160 and the periphery of the substrate 110, between the data pads 170 and the periphery of the substrate 110. The outer guard ring 194 is electrically connected to the scan lines 120 and the data lines 130 respectively. Similarly, the outer guard ring 194 is formed by ESD protection devices 194a.

During the fabrication process, the TFT array substrate 100 tends to accumulate electrostatic charges due to external factors such as transporting or changes in the environment. Thus, when the accumulation of electrostatic charges reaches a certain amount, the circuits and the TFT 152 disposed on the TFT array substrate 100 may be damaged due to the electrostatic discharge. Therefore, the inner guard rings 192 and the outer guard ring 194 are used to dissipate the electrostatic charges into the entire TFT substrate 100, thus preventing localized accumulation of electrostatic charges from damaging the pixel units 150 on the display region 112.

More specifically, the inner guard ring 192 or the outer guard ring 194 is electrically connected in series to the scan lines 120 and the data lines 130 through the ESD protection devices 192a and 194a. When the accumulation of electrostatic charges on the scan lines 120 and the data lines 130 or that on the TFT 152 exceeds the intended load of the scan lines 120 and the data lines 130 or the TFT 152, the electrostatic charges can be dissipated into the entire TFT array substrate 100 through the inner guard ring 192 and/or the outer guard ring 194 to achieve ESD protection.

Nevertheless, damages caused by the accumulation of electrostatic charges are still possible even with the use of the inner guard ring 192 and the outer guard ring 194. Particularly, the scan pads 160 and the data pads 170 are more prone to be damaged since they have larger surface area that facilitates large accumulation of electrostatic charges. Hence, when electrostatic charges cannot be dissipated, the circuits and the TFT 152 disposed on the TFT array substrate 100 will be damaged by the electrostatic charges.

### SUMMARY OF THE INVENTION

Accordingly, the present invention provides an active device array substrate that provides improved ESD protection.

The present invention provides an active device array substrate which includes a substrate, an active device array, a plurality of pad sets, a plurality of connecting lines and a plurality of switch devices. Herein, the substrate has a display region and a peripheral circuit region, and the active device array is disposed on the display region. The pad sets are disposed on the peripheral circuit region and each pad set includes a plurality of pads. A portion of the pads is electrically connected to the active device array. The connecting lines are disposed on the peripheral circuit region. The pad sets are electrically connected to one another through the connecting lines. The switch devices are disposed on the peripheral circuit region. Further, at least one of the switch devices is disposed between two adjacent pads in each pad set, and each switch device is electrically connected to its adjacent pads.

In one embodiment of the present invention, the pad on the outermost side of each pad set includes at least a dummy pad or a common pad. Moreover, the pads on the outermost side of two adjacent pad sets are electrically connected to each other through connecting lines.

In one embodiment of the present invention, the active device array substrate further includes an inner guard ring that is disposed on the peripheral circuit region. The pads on the outermost sides of two adjacent pad sets are electrically connected to each other through the inner guard ring.

In one embodiment of the present invention, the active device array substrate further includes an outer guard ring that is disposed on the peripheral circuit region and is located on the periphery of the active device array and the pad sets. The pads on the outermost sides of two adjacent pad sets are electrically connected to one another through the outer guard ring.

In one embodiment of the present invention, the active device array substrate further includes an inner guard ring that is disposed on the peripheral circuit region. The pads of each pad set that are electrically connected to one another through the connecting lines are further connected by the inner guard ring electrically.

In one embodiment of the present invention, the active device array substrate further includes an outer guard ring that is disposed on the peripheral circuit region and is located on the periphery of the active device array and the pad sets. The pads of each pad set that are electrically connected to each other through the connecting lines are further connected by the outer guard ring electrically.

In one embodiment of the present invention, the pad sets may be gate pad sets or source pad sets.

In one embodiment of the present invention, the active device array includes a plurality of scan lines, a plurality of data lines and a plurality of pixel units. Herein, the scan lines and the data lines are disposed on the substrate, and the scan lines and the data lines divide the display region into a plurality of pixel areas. The pixel units are respectively disposed in one of the pixel areas, and each pixel unit is driven by the corresponding scan line and the corresponding data line.

The present invention provides an active device array substrate which includes a substrate, an active device array, a plurality of pad sets, and a plurality of switch devices. Herein, the substrate includes a display region and a peripheral circuit region and the active device array is disposed on the display region. The pad sets are disposed on the peripheral circuit region. In addition, each pad set includes a plurality of pads. Further, a portion of the pads in each pad set is electrically connected to the active device array, and the pads on each side of each pad set include more than two dummy pads or more than one common pad. The switch devices are disposed on the peripheral circuit region. Further, at least one of the switch devices is disposed between two adjacent pads in each pad set and each switch device is electrically connected to the adjacent pads.

In one embodiment of the present invention, the active device array substrate further includes an inner guard ring that is disposed on the peripheral circuit region. The pads on the outermost side of two adjacent pad sets are electrically connected to each other through the inner guard ring.

In one embodiment of the present invention, the active device array substrate further includes an outer guard ring that is disposed on the peripheral circuit region and is located on the periphery of the active device array and the pad sets. The pads on the outermost sides of two adjacent pad sets are electrically connected to each other through the outer guard ring.

In one embodiment of the present invention, the pad sets may be gate pad sets or source pad sets.

In one embodiment of the present invention, the active device array includes a plurality of scan lines, a plurality of data lines and a plurality of pixel units. Herein, the scan lines and the data lines are disposed on the substrate, and the scan lines and the data lines divide the display region into a plurality of pixel areas. The pixel units are respectively disposed in one of the pixel areas and each pixel unit is driven by the corresponding scan line and the corresponding data line.

In view of the above, the present invention uses the switch devices and the connecting lines to connect each pad set. As a result, the electrostatic charges are conducted to the entire active device array substrate through the connecting lines and the switch devices, reducing the occurrence of damaged caused by electrostatic discharge. Moreover, in the present invention, the dummy pad or the common pad is connected to the outer guard ring or the inner guard ring to reducing the occurrence of damages caused by electrostatic discharge.

In order to the make the aforementioned and other objects, features and advantages of the present invention more comprehensible, preferred embodiments accompanied with figures are described in detail below.

### BRIEF DESCRIPTION OF THE DRAWINGS

FIG. 1 schematically illustrates a conventional TFT array substrate.

FIG. 2 schematically illustrates an active device array substrate according to the first embodiment of the present invention.

FIG. 3 schematically illustrates an active device array substrate according to the second embodiment of the present invention.

FIG. 4 schematically illustrates an active device array substrate according to the third embodiment of the present invention.

FIG. 5 schematically illustrates an active device array substrate according to the fourth embodiment of the present invention.

FIG. 6 schematically illustrates an active device array substrate according to the fifth embodiment of the present invention.

FIG. 7 schematically illustrates an active device array substrate according to the sixth embodiment of the present invention.

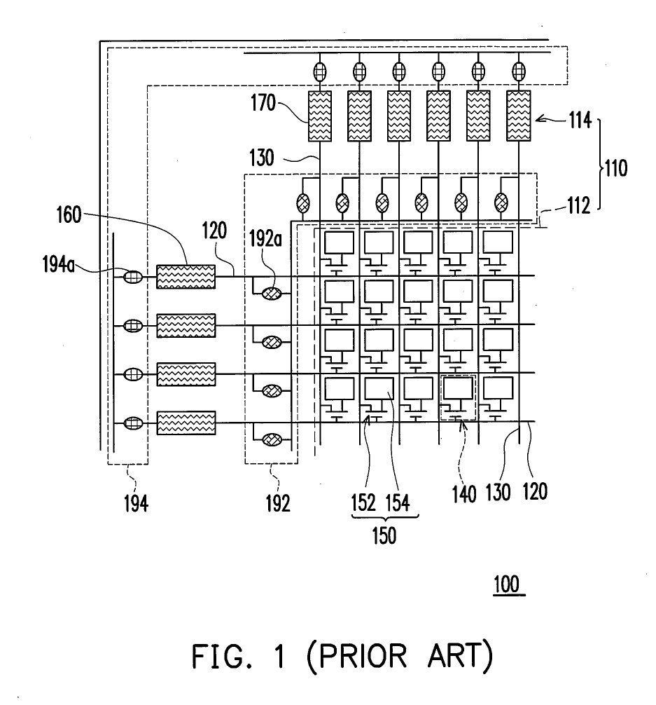

### DESCRIPTION OF EMBODIMENTS

### First Embodiment

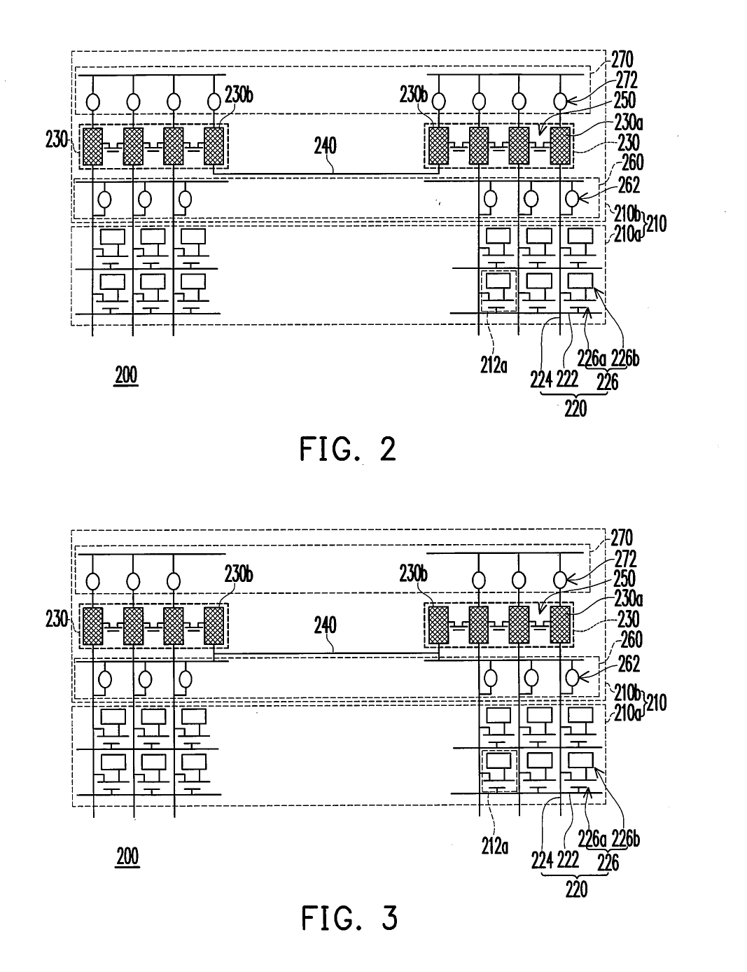

FIG. 2 schematically illustrates an active device array substrate according to the first embodiment of the present invention. Please refer to FIG. 2. According to the present embodiment, an active device array substrate 200 includes a substrate 210, an active device array 220, a plurality of pad sets 230, a plurality of connecting lines 240, and a plurality of switch devices 250. Herein, the substrate 210 has a display region 210a and a peripheral circuit region 210b and the active device array 220 is disposed on the display region 210a. The pad sets 230 are disposed on the peripheral circuit region 210b and the pad sets 230 are electrically connected to one another. Further, each pad set 230 includes a plurality of pads 230a and 230b. The pads 230a of the pad sets 230 are electrically connected to the active device array 220. The connecting lines 240 are disposed on the peripheral circuit region 210b. The pad sets 230 are electrically connected to one another through the connecting lines 240. The switch devices 250 are disposed on the peripheral circuit region 210b. Further, at least one of the switch devices 250 is disposed between two adjacent pads 230a in each pad set 230 or between pads 230a and 230b, and each switch device 250 is electrically connected to the two adjacent pads 230a or 230b.

More specifically, the active device array 220 includes a plurality of scan lines 222, a plurality of data lines 224 and a plurality of pixel units 226. Herein, the scan lines 222 and the data lines 224 are disposed on the substrate 210 and the scan lines 222 and the data lines 224 divide the display region 210a into a plurality of pixel areas 212a. Further, the pixel units 226 are respectively disposed in one of the pixel areas 212a and each pixel unit 226 is driven by the corresponding scan line 222 and the corresponding data line 224. Additionally, the pixel unit 226 includes an active device 226a and a pixel electrode 226b. Herein, the pixel electrode 226b is electrically connected to the active device 226a. Furthermore, in the present embodiment, the switch devices 250 may be thin film transistors having floating gates.

Please refer to FIG. 2 again. According to the present embodiment, to improve the ESD protection, the active device array substrate 200 may include an inner guard ring 260 and an outer guard ring 270. Herein, the inner guard ring 260 and the outer guard ring 270 are disposed on the peripheral circuit region 210b. The inner guard ring 260 includes a plurality of ESD protection devices 262. The outer guard ring 270 includes a plurality of ESD protection devices 272. Further, the pads 230a of each pad set 230 are electrically connected to the inner guard ring 260 and the outer guard ring 270 respectively, and the pads 230b of each pad set 230 are electrically connected to the outer guard ring 270.

In the present embodiment, the pads 230b on the outermost side of each pad set 230 may be dummy pads or common pads. Moreover, the pads 230b on the outermost side of adjacent pad sets 230 are electrically connected to one another through one of the connecting lines 240. Further, the above-mentioned common pads are connected by common lines. It should be noted that the present embodiment is not limited to using two adjacent pad sets 230 that are electrically connected by the connecting line 240. In addition, other pad sets 230 may be disposed between two pad sets 230 that are electrically connected by the connecting line 240. Moreover, the pads 230b that are connected by the connecting lines 240 are not limited to be located on the outermost side of a pad set 230. Additionally, the pads 230b connected by the connecting line 240 may be disposed anywhere in each pad set 230. Furthermore, each pad set 230 is used to electrically connect to a single driver chip. Besides, in the present embodiment, the pad sets 230 are source pad sets. Further, in another embodiment, the pad sets 230 may be gate pad sets. Although, according to the present embodiment, a switch device 250 is disposed between two adjacent pads 230a or between pads 230a and 230b, the present embodiment is not limited to the number of the switch devices 250 disposed.

When a large amount of electrostatic charges is accumulated on the scan line 222 and the data line 224 or the active device 226a, the electrostatic charges will be conducted to the inner guard ring 260 and/or the outer guard ring 270 to achieve ESD protection. However, it is still possible to accumulate a large amount of electrostatic charges in the pad sets 230. Hence, at least one switch device 250 is disposed between two adjacent pads 230a in each pad set 230 or between pads 230a and 230b. In other words, when the accumulation of electrostatic charges on pads 230a or 230b reaches a certain point, the switch device 250 will be turned on due to coupling effect and the accumulated electrostatic charges will be conducted to other neighboring pads 230a or 230b through the switch device 250. Therefore, accumulation of electrostatic charges will not be localized to just one pad 230a or one pad 230b, reducing the occurrence of damages caused by electrostatic discharge.

In addition, the present embodiment uses the connecting lines 240 to electrically connect each pad set 230. As a result, electrostatic charges can be conducted to the entire active device array substrate 200 through the connecting lines 240, reducing the occurrence of damages caused by electrostatic discharge in each pad set 230.

### Second Embodiment

FIG. 3 schematically illustrates an active device array substrate according to the second embodiment of the present invention. Please refer to FIG. 3. The present embodiment is similar to the first embodiment. However, in the second embodiment, the pads 230b in each pad set 230 are electrically connected to the inner guard ring 260. Therefore, the electrostatic charges conducted to the pads 230b in a pad set 230 are not only conducted to another pad set 230 through the connecting lines 240, but also are conducted to the entire active device array substrate 200 through the inner guard ring 260. Further, it should be noted that the pads 230b that are electrically connected to the inner guard ring 260 are not to be electrically connected to the outer guard ring 270 to prevent signal interference during testing.

Similar to the first embodiment, the pads 230b on the outermost side of each pad set 230 may be dummy pads or common pads. Moreover, the pads 230b on the outermost side of adjacent pad sets 230 are electrically connected to one another through one of the connecting lines 240. It should be noted that the present embodiment is not limited to using two pad sets 230 that are electronically connected by the connecting line 240 to be adjacent. In addition, other pad sets 230 may be disposed between two pad sets 230 that are electrically connected by the connecting line 240. Moreover, the pads 230b that are connected by the connecting lines 240 are not limited to being located on the outermost side of each pad set 230. Additionally, the pads 230b connected by the connecting line 240 may be disposed anywhere in each pad set 230. On the other hand, according to the present embodiment, the pad sets 230 are source pad sets. Further, according to another embodiment, the pad sets 230 may be gate pad sets. Although, according to the present embodiment, a switch device 250 is disposed between two adjacent pads 230a or between pads 230a and 230b, the present embodiment is not limited to the number of the switch devices 250 disposed.

### Third Embodiment

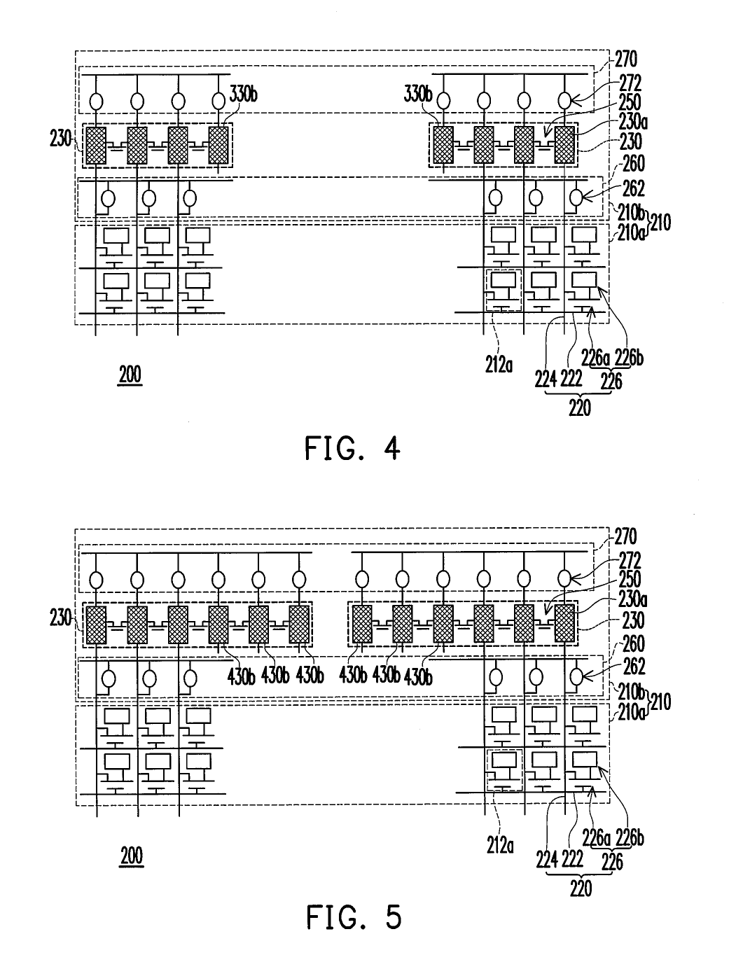

FIG. 4 schematically illustrates an active device array substrate according to the third embodiment of the present invention. Please refer to FIG. 4. The present embodiment is similar to the first embodiment. However, in the third embodiment, the pads 330b in each pad set 230 are common pads and the electrostatic charges accumulated on the pads 230a can be conducted to the entire active device array substrate 200 through the switch device 250 and the pads 330b. Further, according to the present embodiment, the pads 330b are electrically connected to the outer guard ring 270. Further, according to another embodiment, the pads 330b are not electrically connected to the outer guard ring 270.

In addition, the pads 330b described in the present embodiment are not limited to being disposed on the outermost side of each pad set 230, that is to say, the pads 330b may be disposed in anywhere in each pad set 230. On the other hand, according to the present embodiment, the pad sets 230 are source pad sets. However, according to another embodiment, the pad sets 230 may be gate pad sets. Although, according to the present embodiment, a switch device 250 is disposed between two adjacent pads 230a or between pads 230a and 330b, the present embodiment is not limited to the number of the switch devices 250 disposed.

### Fourth Embodiment

FIG. 5 schematically illustrates an active device array substrate according to the fourth embodiment of the present invention. Please refer to FIG. 5. The present embodiment is similar to the first embodiment. However, in the fourth embodiment, each pad set 230 includes more than two pads 430b and the pads 430b are dummy pads. Further, additional pads 430b used as dummy pads are increased on each side of each pad set 230. A switch device 250 is disposed between two adjacent pads 230a or between pads 230a and 430b. As a result, when there is an accumulation of electrostatic charges on the pads 230a, electrostatic charges can be conducted to the pads 430b that is on the outermost side of the pad set 230 through the switch device 250 and the pads 430b to reduce the occurrence of damages caused by electrostatic discharge.

Further, according to the present embodiment, the pads 430b are electrically connected to the outer guard ring 270. However, according to another embodiment, the pads 430b are not electrically connected to the outer guard ring 270. On the other hand, in the present embodiment, the pad sets 230 are source pad sets. However, in another embodiment, the pad sets 230 may be gate pad sets. Although, according to the present embodiment, a switch device 250 is disposed between adjacent pads 230a or between pads 230a and 430b, the present embodiment is not limited to the number of the switch devices 250 disposed.

### Fifth Embodiment

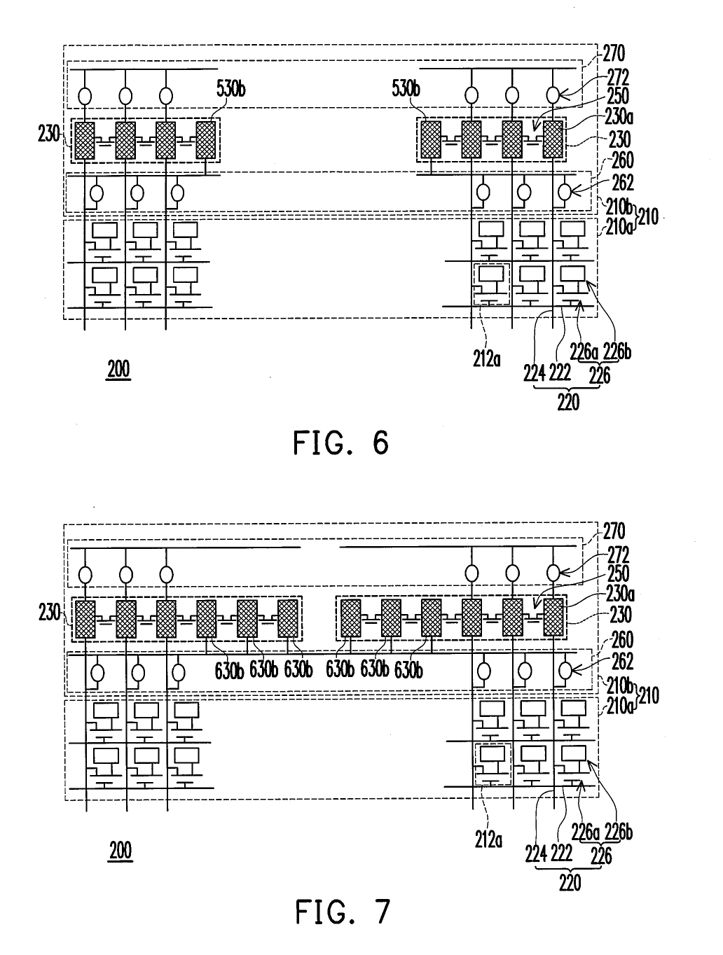

FIG. 6 schematically illustrates an active device array substrate according to the fifth embodiment of the present invention. Please refer to FIG. 6. The present embodiment is similar to the first embodiment. However, in the fifth embodiment, the pads 530b on the outermost side of each pad set 230 may be dummy pads or common pads. Moreover, the pads 530b on the outermost side of adjacent pad sets 230 are electrically connected to one another through the inner guard ring 260. Hence, electrostatic charges conducted to the pads 530b can be further conducted to the entire active device array substrate 200 through the inner guard ring 260. Further, it should be noted that the pads 530b connected to the inner guard ring 260 are not to be electrically connected to the outer guard ring 270 to prevent signal interference during testing.

On the other hand, according to the present embodiment, the pad sets 230 are source pad sets. However, in another embodiment, the pad sets 230 may be gate pad sets. Although, according to the present embodiment, a switch device 250 is disposed between two adjacent pads 230a or between pads 230a and 530b, the present embodiment is not limited to the number of the switch devices 250 disposed.

### Sixth Embodiment

FIG. 7 schematically illustrates an active device array substrate according to the sixth embodiment of the present invention. Please refer to FIG. 7. The present embodiment is similar to the fourth embodiment. However, in the sixth embodiment, the each pad set 230 includes more than two pads 630b and the pads 630b are dummy pads. Further, the pads 630b used as dummy pads are electrically connected to one another through the inner guard ring 260. As a result, when there is an accumulation of electrostatic charges on the pads 230a or 630b, the accumulated electrostatic charges are conducted to the entire active device array substrate 200 through the switch device 250 and the inner guard ring 260 to reduce the occurrence of damages caused by electrostatic discharge in the pads 230a. It should be noted that the pads 630b connected to the inner guard ring 260 are not to be electrically connected to the outer guard ring 270 to prevent signal interference during testing.

On the other hand, according to the present embodiment, the pad sets 230 are source pad sets. Further, according to another embodiment, the pad sets 230 may be gate pad sets. Although, according to the present embodiment, a switch device 250 is disposed between two adjacent pads 230a, between pads 230a and 630b, and between two adjacent pads 630b, the present embodiment is not limited to the number of the switch devices 250 disposed.

In view of the above, the active device array substrate of the present invention has at least the following advantages:

1. The present invention uses the switch devices to connect two adjacent pads and the connecting lines to connect each pad set. As a result, the electrostatic charges generated are conducted to the entire active device array substrate through the connecting lines and the switch devices, reducing the occurrence of damages caused by electrostatic discharge.

2. The present invention increases the number of dummy pads disposed and uses switch devices to connect regular pads and dummy pads. As a result, electrostatic discharge is more likely to occur on dummy pads, lowering the possibilities of electrostatic discharge on regular pads.

3. The present invention connects dummy pads or common pads to an outer guard ring or an inner guard ring which allows conduction of electrostatic charges to the entire active device array substrate, reducing the occurrence of damages caused by electrostatic discharge.

Although the present invention has been disclosed above by the embodiments, they are not intended to limit the present invention. Anybody skilled in the art can make some modifications and alteration within the spirit and scope of the present invention. Therefore, the protecting range of the present invention falls in the appended claims.

What is claimed is:

1. An active device array substrate, comprising:
a substrate having a display region and a peripheral circuit region;
an active device array disposed on the display region;
a plurality of pad sets disposed on the peripheral circuit region, wherein each pad set comprises a plurality of pads and a portion of the pads in each pad set is electrically connected to the active device array;
a plurality of connecting lines disposed on the peripheral circuit region and the pad sets are electrically connected to one another through the connecting lines; and
a plurality of switch devices disposed on the peripheral circuit region, wherein at least one of the switch devices is disposed between two adjacent pads in each pad set and each switch device is electrically connected to the two adjacent pads

2. The active device array substrate of claim 1, wherein the pads on the outermost side of each pad set comprises at least dummy pads or common pads, and the pads on the outermost side of the two adjacent pad sets are electrically connected to each other by one of the connecting lines.

3. The active device array substrate of claim 2, further comprising an inner guard ring disposed on the peripheral circuit region and the pads on the outermost side of two adjacent pad sets are electrically connected to each other through the inner guard ring.

4. The active device array substrate of claim 2, further comprising an outer guard ring disposed on the peripheral circuit region and located on the periphery of the active device array and the pad sets, and the pads on the outermost sides of two adjacent pad sets are electrically connected to each another through the outer guard ring.

5. The active device array substrate of claim 1, further comprising an inner guard ring disposed on the peripheral circuit region and the pads of each pad set are electrically connected to one another through the inner guard ring.

6. The active device array substrate of claim 1, further comprising an outer guard ring disposed on the peripheral circuit region and located on the periphery of the active device array and the pad sets, and the pads of the pad sets are electrically connected to one another through the outer guard ring.

7. The active device array substrate of claim 1, wherein the pad sets comprises gate pad sets or source pad sets.

8. The active device array substrate of claim 1, wherein the active device array comprising:
a plurality of scan lines disposed on the substrate;
a plurality of data lines disposed on the substrate, wherein the scan lines and the data lines divide the display region into a plurality of pixel areas; and
a plurality of pixel units respectively disposed in one of the pixel areas and each pixel unit is driven by the corresponding scan line and the corresponding data line.

9. An active device array substrate, comprising:
a substrate having a display region and a peripheral circuit region;
an active device array disposed on the display region;
a plurality of pad sets disposed on the peripheral circuit region, wherein each pad set comprises a plurality of pads and a portion of the pads in each pad set is electrically connected to the active device array and each pad set comprises more than two dummy pads or more than one common pad on each side of each pad set; and
a plurality of switch devices disposed on the peripheral circuit region, wherein at least one of the switch devices is disposed between two adjacent pads in each pad set and each switch device is electrically connected to the adjacent pads.

10. The active device array substrate of claim 9, further comprising an inner guard ring disposed on the peripheral circuit region and the pads on the outermost side of two adjacent pad sets are electrically connected to each other through the inner guard ring.

11. The active device array substrate of claim 9, further comprising an outer guard ring disposed on the peripheral circuit region and located on the periphery of the active device array and the pad sets, and the pads on the outermost sides of two adjacent pad sets are electrically connected to each other through the outer guard ring.

12. The active device array substrate of claim 9, wherein the pad sets comprises gate pad sets or source pad sets.

13. The active device array substrate of claim 9, wherein the active device array comprising:
a plurality of scan lines disposed on the substrate;
a plurality of data lines disposed on the substrate, wherein the scan lines and the data lines divide the display region into a plurality of pixel areas; and
a plurality of pixel units respectively disposed in one of the pixel areas and each pixel unit is driven by the corresponding scan line and the corresponding data line.
